(19) United States
(12) Patent Application Publication
(10) Pub. No.: US 2007/0242209 A1
(43) Pub. Date: Oct. 18, 2007

(54) LCD having switchable viewing angles

(75) Inventor: Chi-Huang Lin, Yungkang City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Toppoly Optoelectronics Corp.

(21) Appl. No.: 11/402,444

(22) Filed: Apr. 12, 2006

(51) Int. Cl. C09K 19/02

(52) U.S. Cl. 349/167

(57) ABSTRACT

An LCD having switchable viewing angles comprises a display panel and a light source. The display panel comprises a first and a second substrates and a liquid crystal layer disposed between the first and the second substrates, wherein the liquid crystal layer comprises a phase retardation having a predetermined range of value more than wavelength of light produced form the light source so that the LCD displays at least a bright state and at least two dark states, or displays at least two bright states and at least a dark state. Therefore, the LCD provides switchable viewing angles.

### BACKGROUND OF THE INVENTION

1. Field of the Invention

The invention relates to a liquid crystal display (LCD), and more particularly, to an LCD that has switchable viewing angles.

2. Description of the Prior Art

Currently, LCDs represent a common flat panel display technology. Because LCDs have light weight, thinness, low energy requirements, no radiation, and other good qualities, they have become the main stream in the market and are widely used in notebooks, personal computers, and other communication and information equipments. Furthermore, LCDs also tend to replace the traditional cathode ray tube (CRT) monitors and CRT TVs in recent years.

With an increase in the LCD sizes, limitations in viewing angles of conventional twisted nematic (TN) type LCDs have been observed. To remove the limitations in the viewing angles and allow the users to observe undistorted images at various viewing angles, viewing angle expanding technology has been researched. For example, the use of a viewing angle compensation film, forming different pre-tilt angle directions in a pixel region, or in-plane switching (IPS) type LCDs are proposed to expand the viewing angles of LCDs. Although the viewing angle expanding technology is essential to increase a contrast of LCD, the viewing angles are limited in some LCD applications so as to allow the user to see the image only at specific angles. For example, for security or privacy, when the user operates the notebook computer in public, it is desirable to use the LCD with a narrow viewing angle to allow the user to see the useful information (clear image) from the front of the display and prevent the others aside of the user from seeing the image. However, in some situations, the user may want to share the information from the notebook or personal computer with others, and which needs a wide viewing angle. Therefore, LCDs with fixed viewing angles cannot meet the requirement of market any longer. LCDs with multi-functions to provide switchable viewing angles become more and more important.

### SUMMARY OF THE INVENTION

According to an embodiment of the present invention, an LCD having switchable viewing angles comprises a display panel and a light source. The display panel comprises a first and a second substrates and a liquid crystal layer disposed between the first and the second substrates, wherein the liquid crystal layer comprises a phase retardation having a predetermined range of value more than wavelength of light produced form the light source so that the LCD displays at least a bright state and at least two dark states, or displays at least two bright states and at least a dark state. Therefore, the LCD provides switchable viewing angles.

Another embodiment of such a driving method involves an LCD with switchable viewing angles. In this method, an LCD is provided, wherein the LCD displays a first state when the applied voltage is V₁ or V₃, and displays a second state when the applied voltage is V₂, V₁ being less than V₂, V₂ being less than V₃, wherein the first and second states are a bright state or a dark state, but are different states, wherein the LCD comprises a transmittance versus applied voltage curve (V-T curve), the V-T curve comprising at least a first region between V₁ and V₂, and a second region between V₂ and V₃. Then, the LCD can be subjected to display a first viewing angle by applying a first voltage in the first voltage range of V1 to V2, and the LCD can be subjected to display a second viewing angle by applying a second voltage in the second voltage range of V2 to V3.

Another exemplary embodiment of such as LCD comprises at least two dark states or two bright states so that the LCD has a first display mode and a second display mode, wherein the first display mode and the second display mode also have different viewing angles. Accordingly, the LCD provides two display modes with a wide viewing angle and a narrow viewing angle individually.

### BRIEF DESCRIPTION OF THE DRAWINGS

FIG. 1 is a sectional view of a portion of an LCD with switchable viewing angles according to the present invention.

FIG. 2 is a transmittance rate vs. applied voltage chart of the LCD shown in FIG. 1.

FIG. 3 is a schematic diagram of rotation states of liquid crystal molecules of the liquid crystal layer shown in FIG. 1.

FIGS. 4-5 are equal contrast ratio contours of the first display mode and the second display mode respectively.

FIG. 6 is a transmittance rate vs. applied voltage chart of an LCD according to another embodiment of the present invention.

FIG. 7 is a schematic view of an embodiment of an electronic device employing an embodiment of a liquid crystal display of the present invention.

### DETAILED DESCRIPTION

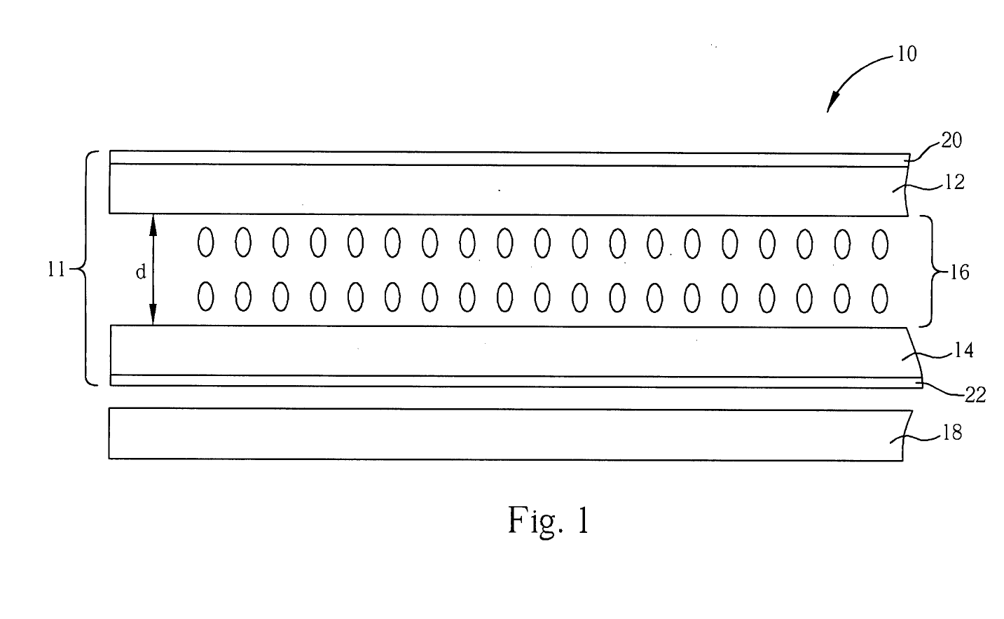

As shown in FIG. 1, an LCD 10 with switchable viewing angles according to the present invention includes an LCD panel 11, which comprises a top substrate 12, a bottom substrate 14, a liquid crystal layer 16 positioned between the top substrate 12 and the bottom substrate 14, and two polarizers 20, 22 on outer surfaces of the top substrate 12 and the bottom substrate 14 respectively. The liquid crystal layer 16 has a cell gap “d” between the top substrate 12 and the bottom substrate 14, and the cell gap “d” means the height of the liquid crystal layer 16. The LCD panel 11 may selectively comprise two alignment films or alignment protrusions (not shown) on the inner surfaces of the top substrate 12 and the bottom substrate 14. In this embodiment, the LCD panel 11 is a multi-domain vertical alignment (MVA) LCD panel. The LCD 10 is applied to a display device or an electronic device. The LCD 10 further comprises a back light module 18 serving as a back light source of the LCD panel 11 and providing light to the LCD panel 11.

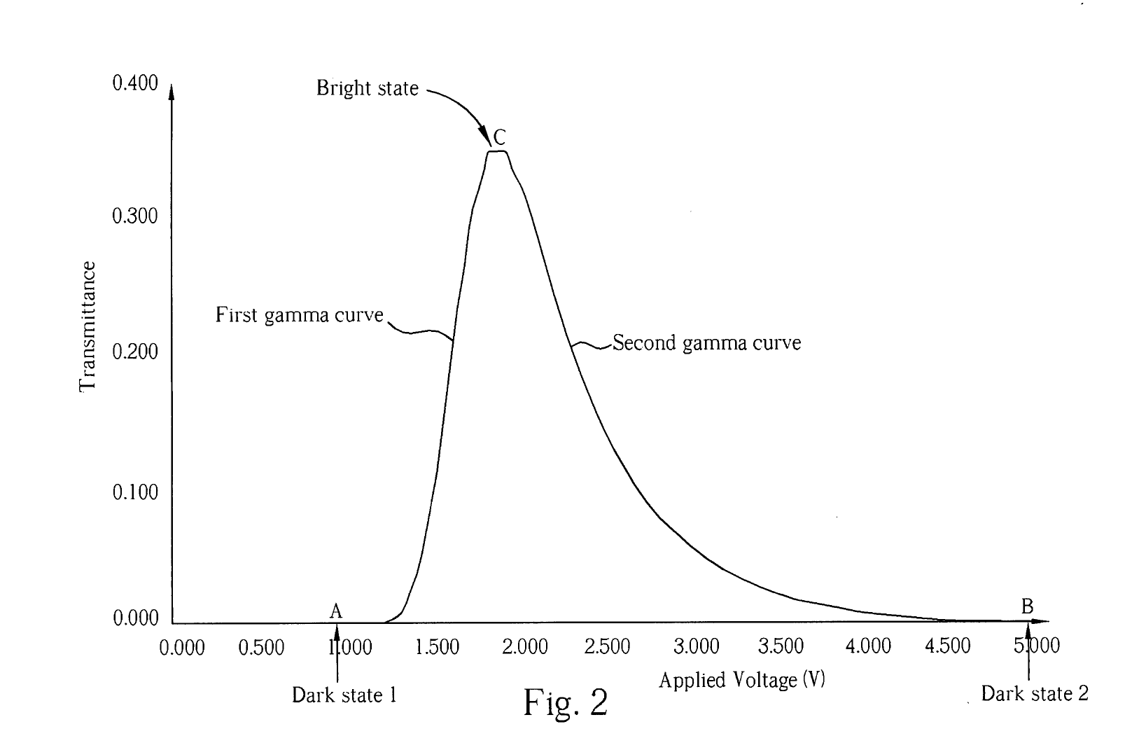

The liquid crystal layer 16 of the LCD 10 comprises a phase retardation, which is determined by Δn·d, wherein “d” represents the cell gap “d” of the LCD panel 11, and “Δn” represents a refractive index retardation of the liquid crystal molecules in the liquid crystal layer 16. For providing switchable viewing angles, the phase retardation of the liquid crystal layer 16 has a range more than a predetermined value, and the predetermined value can be selected by wavelength of light produced from the back light module 18. When the phase retardation of the liquid crystal layer 16 is more than the determined value, such as 550 nm, the transmittance rate vs. applied voltage curve (V-T curve) of the LCD 10 will have two troughs and one peak. The troughs and peak of the V-T curve of the LCD 10 represent the dark states and bright state individually. A transmittance rate vs. applied voltage chart of the LCD 10 is shown in FIG. 2, wherein the phase retardation is more than 550 nanometers (nm) and is about 605 nanometers. Generally, the V-T curve of the LCD 10 can be determined by the following equation:
T=T₀sin(2β)sin(π·Δn·d/λ) (a)

In the equation (a), “T” represents transmittance rate of the LCD 10; “T₀” represents the original strength of light from the back light module 18; “Δn·d” represents the phase retardation of the liquid crystal layer 16; “λ“ represents the wave length of light from the back light module 18; and “β” represents the included angle of the polarizers and aligned liquid crystal layer 16. Therefore, since the phase retardation value of the liquid crystal layer 16 is about 650 nanometers, the V-T curve of the LCD 10 has two troughs A, B and one peak C, as shown in FIG. 2. Each of the troughs A and B represents a dark state (black state) of the LCD 10, and the peak C represents a bright state (white state) of the LCD 10. Therefore, the LCD 10 comprises a first display mode and a second display mode. Both of the first and second display modes comprise a bright state and a dark state individually.

In this embodiment of the present invention, the first display mode has a dark state, the trough A, corresponding to the applied voltage of about 1.0 voltages (v), and a bright state, the peak C, corresponding to the applied voltage of about 1.7 v. Therefore, the first display mode has a corresponding first region of V-T curve with an applied voltage range of about 1.0 v to 1.7 v. On the other hand, the second display mode has a bright state, the peak C, corresponding to the applied voltage of about 1.7 v and a dark state, the trough B, corresponding to the applied voltage about 5.0 v. Accordingly, the second display mode has a corresponding second region of V-T curve with an applied voltage of about 1.7 v to 5.0 v.

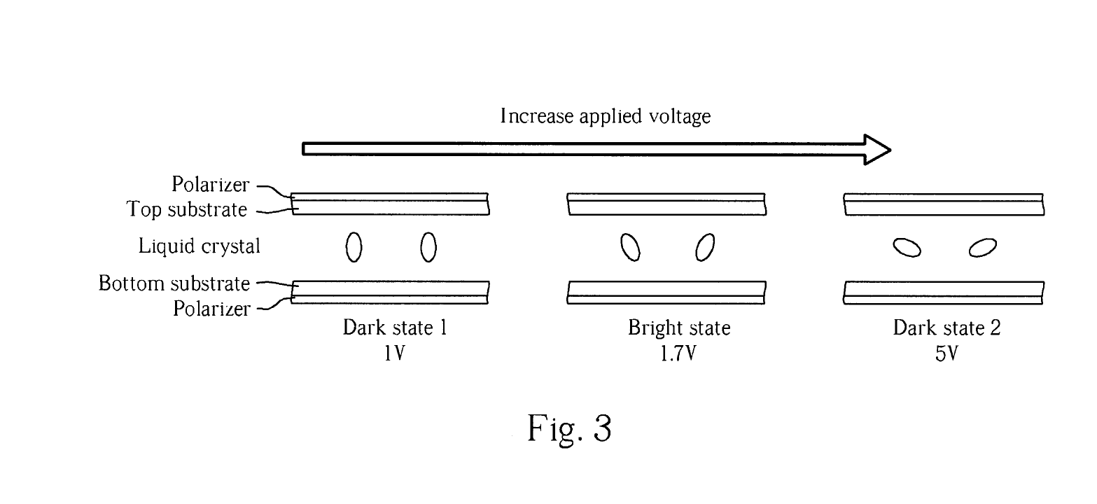

FIG. 3 is a schematic diagram of rotation states of liquid crystal molecules of the liquid crystal layer 16 shown in FIG. 1. The direction of the arrow illustrates the increasing direction of the applied voltage. As shown in FIG. 3, when the applied voltage is 1.0 v, the LCD 10 has a first dark state. As the applied voltage increased, the liquid crystal molecules rotate. When the applied voltage becomes 1.7 v, the LCD 10 has a bright state. And when the applied voltage is 5.0 v, the LCD 10 has a second dark state.

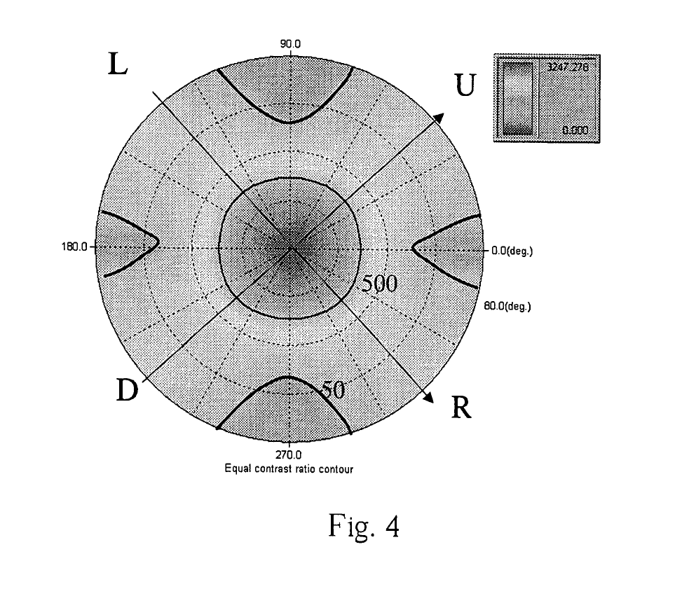

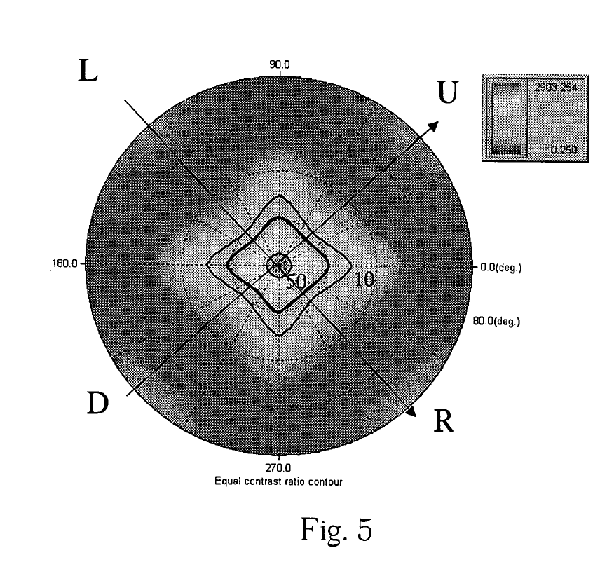

FIGS. 4-5 are equal contrast ratio contours of the first display mode and the second display mode respectively, wherein the largest scale of the diagram is 80 degrees. As shown in FIG. 4, the first display mode has a contrast ratio of 500 at about 30 degrees, and the contrast ratio of 50 of the first display mode is more than 80 degrees. Therefore, the first display mode is a wide viewing angle mode and its viewing angle is up to 170 degrees experimentally. Referring to FIG. 5, the contours of contrast ratio 10 and 50 are located inner the scale of 40 degrees and 20 degrees respectively so that the viewing angle of the second display mode is less than 40 degrees. Accordingly, the second display mode is a narrow viewing mode.

According to this embodiment, the first display mode and the second display mode are a wide viewing angle mode and a narrow viewing angle mode respectively, the LCD 10 has two different viewing angles in the first display mode and the second display mode. When operating the LCD 10, one could switch the LCD 10 into the first display mode or the second display mode through commanding the LCD 10 to supply different applied voltage ranges to the LCD panel 11 according to his requirement. For example, if a user likes to use the LCD 10 in private, he could set the LCD 10 to the second display mode so that the display image of the LCD 10 has a narrow viewing angle with the second region of V-T curve shown in FIG. 2; meanwhile, the applied voltage is set in a range of about 1.7 v to 5.0 v. However, when the user wants to share the display image with others, he could set the LCD 10 to the first display mode to make it has a wide viewing angle with the first region of V-T curve shown in FIG. 2. In this situation, the applied voltage is set in a range of about 1.0 v to 1.7 v.

However, according to the spirit of the present invention, the number of dark or bright states is not limited. For instance, in a second embodiment of the present invention, the LCD may has two bright states and only one dark state and comprises two display modes with different viewing angles through supplying different applied voltage ranges, wherein the two display modes has the same applied voltage value for their dark states and different voltage values for their bright states.

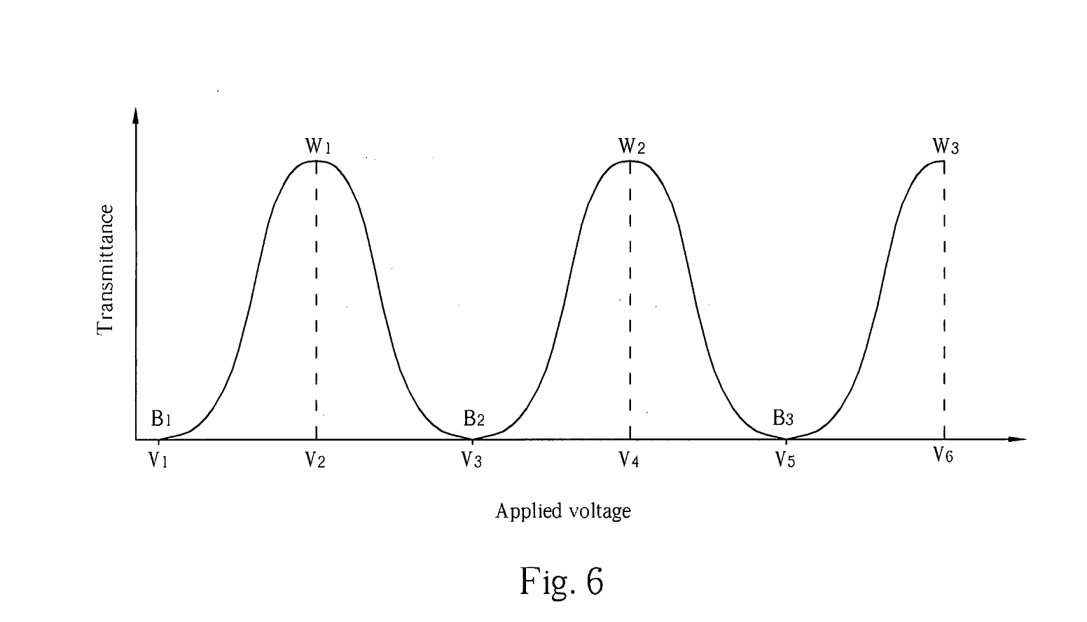

FIG. 6 is a V-T chart of an LCD according to another embodiment of the present invention. According to the equation (a), when the phase retardation value is high enough, the V-T curve may has a plurality of peaks W₁, W₂, W₃ and a plurality of troughs B₁, B₂, B₃. Therefore, a designer may choose a plurality of applied voltage ranges for setting several display modes with various viewing angles of the LCD. For example, the designer may set a first display mode corresponding to a first applied voltage range of V₁ to V₂, set a second display mode corresponding to a second applied voltage range of V₃ to V₄, and set a third display mode corresponding to a third applied voltage range of V₅ to V₆. Therefore, the LCD has three dark states at troughs B₁, B₂, B₃ and three bright states at peaks W₁, W₂, W₃. In other words, the LCD displays dark states when the applied voltage is about V₁, V₃, or V₅, and displays bright states when the applied voltage is about V₂, V₄, or V₆. Furthermore, the LCD also has three V-T curve regions: the B₁- W₁ curve, the B₂-W₂ curve, and the B₃-W₃ curve of the first display mode, the second display mode, and the third display mode respectively. On the other hand, a designer may design the LCD with only two display modes or more than three display modes by setting the applied voltage range of each display mode according to the requirement. In addition, the several display modes may have a common dark state or a common bright state.

On the other hand, designer may design the V-T curve of the LCD by determining the phase retardation value of the LCD. When determining the phase retardation, which is defined as (Δn·d), the refractive index retardation and the cell gap of the liquid crystal layer are variable factors. One aspect of the determination is to select liquid crystal molecules according to its birefreingence property, which relates to the refractive index retardation of the liquid crystal molecules. In another aspect, the designer may adjust the cell gap “d” of the liquid crystal layer of the LCD. Since the phase retardation and the cell gap have a direct proportion, the phase retardation will have a great value when the liquid crystal layer has a large cell gap. Therefore, the designer can adjust the value of the cell gap to obtain a preferable phase retardation value resulted in a preferable V-T curve. Accordingly, the designer can choose the preferable ranges of the applied voltage to determine various display modes with different viewing angles. According to various embodiments, the phase retardation of the LCD can be between about 500 nm to 900 nm.

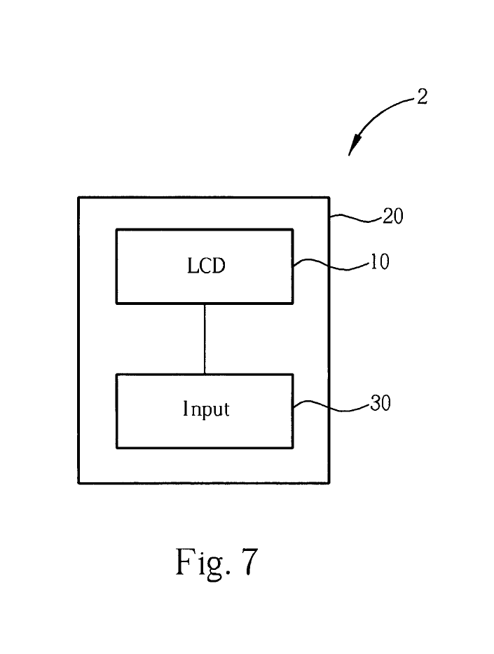

FIG. 7 schematically shows an embodiment of an electronic device 2 employing an embodiment of a liquid crystal display. The electronic device 2 may be a portable device such as a PDA, notebook computer, tablet computer, cellular phone, or a display monitor device, etc. Generally, the electronic device 2 includes a housing 20, an LCD 10 such as shown in FIG. 1, and an input 30. Further, the input 30 is operatively coupled to the LCD and provides an output voltage powering the LCD to display images.

According to various embodiments of the present invention, a phase retardation value of about 500 to 900 nanometers is supplied for providing an LCD with a V-T curve having at least two peaks or at least two troughs. Therefore, the LCD comprises at least two dark states or at least two white blacks and also has at least two display modes, wherein one display mode is a wide viewing mode and another display mode is a narrow viewing mode. Thus, the LCD has switchable viewing angles.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A liquid crystal display (LCD) having switchable viewing angles, the LCD comprising:
a first and a second substrates;
a liquid crystal layer disposed between the first and the second substrates; and
a light source;
wherein the liquid crystal layer has a phase retardation with a predetermined range of value more than wavelength of light produced from the light source.

2. The LCD as claimed in claim 1, wherein the LCD displays a first state when a applied voltage is V₁ or V₃, and displays a second state when a applied voltage is V₂, V₁ being less than V₂, V₂ being less than V₃, wherein the first and second states are a bright state or a dark state, but are different states.

3. The LCD as claimed in claim 2, wherein the LCD displays two dark states at V₁ and V₃ of the applied voltage, and one bright state at V₂.

4. The LCD as claimed in claim 2, wherein the LCD displays two bright states at V₁ and V₃ of the applied voltage, and one dark state at V₂.

5. The LCD as claimed in claim 2, wherein the LCD comprises a transmittance versus applied voltage curve (V-T curve), the V-T curve comprising at least a first region between V₁ and V₂, and a second region between V₂ and V₃.

6. The LCD as claimed in claim 5, wherein the V-T curve comprises two peaks and one trough, the LCD displays two bright states and one dark state.

7. The LCD as claimed in claim 5, wherein the V-T curve comprises two troughs and one peak, the LCD displays two dark states and one bright state.

8. The LCD as claimed in claim 5, wherein a viewing angle in the first region is different from a viewing angle in the second region.

9. The LCD as claimed in claim 1, wherein the predetermined range of value of the phase retardation is between about 500 to 900 nanometers.

10. The LCD as claimed in claim 1, wherein the phase retardation is determined by Δn·d, wherein the “d” represents a cell gap of a liquid crystal layer of the LCD, and the “Δn” represents a refractive index retardation of liquid crystal molecules of the LCD.

11. The LCD as claimed in claim 1, wherein the LCD comprises two bright states and two dark states.

12. An electronic device, comprising:
an LCD as claimed in claim 1; and
an input is operatively coupled to the LCD and provides an output voltage powering the LCD to display images.

13. A method of driving an LCD with switchable viewing angles, comprising:
providing an LCD, wherein the LCD displays a first state when the applied voltage is V₁ or V₃, and displays a second state when the applied voltage is V₂, V₁ being less than V₂, V₂ being less than V₃, wherein the first and second states are a bright state or a dark state, but are different states, wherein the LCD comprises a transmittance versus applied voltage curve (V-T curve), the V-T curve comprising at least a first region between V₁ and V₂, and a second region between V₂ and V₃;
subjecting the LCD to display a first viewing angle by applying a first voltage in the first voltage range of V1 to V2; and
subjecting the LCD to display a second viewing angle by applying a second voltage in the second voltage range of V2 to V3.

14. The method as claimed in claim 13, wherein the V-T curve comprises two peaks and one trough, and the first state is a bright state, the second state is a dark state.

15. The method as claimed in claim 13, wherein the V-T curve comprises one peak and two troughs, and the first state is a dark state, the second state is a bright state.

16. The method as claimed in claim 13, wherein the value of the phase retardation has a range of about 500 to 900 nanometers.

17. The method as claimed in claim 13, wherein the phase retardation is determined by Δn·d, wherein the “d” represents a cell gap of a liquid crystal layer of the LCD, and the “Δn” represents a refractive index retardation of liquid crystal molecules of the LCD, and the method further comprises a step of determining the phase retardation by adjusting the cell gap of the liquid crystal layer.
